(19) United States
(12) Patent Application Publication
(10) Pub. No.: US 2016/0049983 A1
(43) Pub. Date: Feb. 18, 2016

(54) APPARATUS FOR HOLDING A MOBILE COMMUNICATION DEVICE

(71) Applicant: ALAN S RIPKA, NEW YORK, NY (US)

(72) Inventor: ALAN S RIPKA, NEW YORK, NY (US)

(21) Appl. No.: 14/827,304

(22) Filed: Aug. 15, 2015

Related U.S. Application Data
(60) Provisional application No. 62/038,024, filed on Aug. 15, 2014.
(60) Provisional application No. 62/079,127, filed on Nov. 13, 2014.

(51) Int. Cl. H04B 1/3888; H04B 1/3827

(52) U.S. Cl. CPC H04B 1/3888; H04B 1/385; H04B 2001/3861

(57) ABSTRACT

An apparatus for holding a mobile communication device, comprising at least one finger-receiving and engaging structure fixable to a mobile communication device. The finger-receiving and engaging structure receives at least one finger of a hand of a user when engaged with the mobile communication device so that when in use the mobile communication device is secured to said at least one finger and extendable in a cantilevered fashion from said at least one finger of the hand the user.

### CROSS REFERENCE TO RELATED APPLICATIONS

The present invention is a US Utility application of U.S. Provisional Application Ser. No. 62/079,127, filed Nov. 13, 2014 and U.S. Provisional Application Ser. No. 62/038,024, filed Aug. 15, 2014, which are incorporated herein in their entirety.

### BACKGROUND

The present invention relates to an apparatus for holding a mobile communication device. More particularly, the present invention relates to an apparatus for holding a mobile communication device such as a cellphone, smartphone, personal digital assistant, camcorder, camera, tablet computer, and the like.

As the trend continues towards larger screen sizes for communication devices such as cellphones, and for other personal data appliances, such as iPads and tablets, the difficulty of holding the communication device comfortably and conveniently in one hand becomes more problematic. This is particularly true when performing a one-handed operation, such as using the communication device to take a self portrait (typically called a “selfie”) or for one-handed texting.

The trend towards even larger sized cellphone screens makes the problems solved by the inventive apparatus more important because it is that much harder to do on-handed texting and screen navigation, and other manipulations of the user input devices of the mobile communication device, such as snapping a photo or controlling a video camera. These problems are particularly pronounced when taking a self-portrait or selfie, where the communication device is usually held at an extended distance from the user's face in an outstretched hand, while ideally being held as steady as possible to prevent taking a blurry picture.

When taking a selfie, the phone is typically held at the fingertips of an outstretched hand with the arm of the user extending the phone as far as practical to obtain a desired scene frame (such as a self-portrait or group shot). Typically, it is difficult to get to the phone buttons, like the camera shutter, by the thumb or fingers of the hand holding the phone, if one does not perch the phone at the ends of the finger tips (barely holding onto the bottom of the phone). The result is that the holding of the communication device become precarious and the shot become unsteady and awkward.

Examples of prior attempts to provide a finger grip for a cellphone include CN203775275 U, which shows a finger grip for a cellphone with an adjustable buckle to enable one handed operation and to maintain the phone easily from the palm; EP2670053 A1 which shows a case with a pair of ring sections into which a user's middle finger and ring finger are inserted to enable the use of a mobile terminal with one hand; JP2013215460 A2 which shows a smart phone case with a finger insertion member provided on the back face to form a finger insertion hole for inserting fingers in an inclined direction. Other examples include KR200466549 Y1, CN203423721 U, KR101185358 B1, CN203244052 U, KR101370928 B1, US20130079070, CN103494423 A, CN103685620 A, US20130176412, U.S. Pat. No. 7,706,673, U.S. Pat. No. 8,002,480. In the non-patent literature, examples of prior attempts can be found at shop.flygrip.com/pages/features, and trendhunter.com/trends/fingergripping-phone-holders.

### SUMMARY OF THE INVENTION

The present invention is intended to overcome the drawbacks of the prior attempts and provide an apparatus for holding a mobile communication device so that the mobile communication device is held securely with enhanced dexterity for manipulation and access of touchscreen user inputs and physical buttons for controlling the mobile communication device. In accordance with an aspect of the present invention, an apparatus is provided for holding a mobile communication device, comprising at least one finger-receiving and engaging structure fixable to a mobile communication device. The finger-receiving and engaging structure receives at least one finger of a hand of a user when engaged with the mobile communication device so that when in use the mobile communication device is secured to said at least one finger and extendable in a cantilevered fashion from said at least one finger of the hand the user.

### BRIEF DESCRIPTION OF THE DRAWINGS

FIG. 1 is a perspective view of a non-limiting exemplary embodiment of the inventive apparatus disposed on a hard plastic case configured and dimensioned for receiving, engaging and supporting a mobile communication device, such as a cell phone, showing finger-engaging structures comprised of finger tubes;

FIG. 2 is another perspective view of the embodiment of the inventive apparatus shown in FIG. 1 showing the hard plastic case defining an internal cavity for receiving, engaging, and supporting a mobile communication device;

FIG. 3 is a back view of the embodiment of the inventive apparatus shown in FIG. 1, showing the finger-engaging structures disposed at an ergonomic angle relative to the display screen of a mobile communication device;

FIG. 4 is a perspective view of another non-limiting exemplary embodiment of the inventive apparatus for holding a mobile communication device showing finger-engaging structures comprised of collapsable finger sleeves;

FIG. 5 is another perspective view of the embodiment of the inventive apparatus shown in FIG. 4 showing the collapsable finger sleeves collapsed tight against the back of the shell case;

FIG. 6 is a back view of the embodiment of the inventive apparatus shown in FIG. 4, showing the finger-engaging structures disposed at the ergonomic angle relative to the display screen of a mobile communication device held in the hard plastic case;

FIG. 7 is a back view of another non-limiting, exemplary embodiment of the inventive apparatus for holding a mobile communication device showing the finger-engaging structures comprised of a downwardly opening, or upside-down pocket, that receives one or more fingers of the user;

FIG. 8 is a back view of another non-limiting, exemplary embodiment of the inventive apparatus for holding a mobile communication device showing the finger-engaging structures comprised of a sleeve having a slanted edge for receiving and engaging with one or more fingers of the user;

FIG. 9 is a perspective view of another non-limiting exemplary embodiment of the inventive apparatus for holding a mobile communication device showing an antenna-like device;

FIG. 10 is a front view of the embodiment shown in FIG. 9, showing the antenna-like device positioned in a stowed location against the cell phone case;

FIG. 11 is a perspective view of the embodiment shown in FIG. 9, showing the cell phone case positioning the cell phone showing the antenna-like device pivoted from the stowed location and pulled down from the side of the phone to enable extending the phone away from the body of the user;

FIG. 12 is a perspective view of the embodiment shown in FIG. 9, showing a plug connected to an access port of the cellphone and wired through a hollow in the antenna-like device to the switch;

FIG. 13 schematically illustrates an arc of enhanced thumb access to the display screen and buttons on the face and sides of the cellphone in accordance with the use of the inventive apparatus;

FIG. 14 is a photo showing a non-limiting, experimental exemplary embodiment of the inventive apparatus disposed directly on the back showing finger-engaging structures comprised of self-adhesive finger loops;

FIG. 15 is a photo showing the back of an exemplary embodiment shown in FIG. 14;

FIG. 16 is a photo showing a side perspective view of the exemplary embodiment shown in FIG. 14;

FIG. 17 is a photo showing the exemplary embodiment shown in FIG. 14, with the phone being securely held by the finger tips of a user;

FIG. 18 is a photo showing the user held by the exemplary embodiment shown in FIG. 14, showing the perspective from the user looking at the display screen of the cellphone held out extended from the outstretched arm of the user;

FIG. 19 is a perspective back view of another non-limiting exemplary embodiment of the inventive apparatus for holding a mobile communication device showing fold-away finger loops disposed in an open position along a bottom edge of a phone case;

FIG. 20 is a perspective front view of the embodiment shown in FIG. 19, showing the fold-away finger loops disposed in an open position along a bottom edge of a phone case;

FIG. 21 is a perspective back view of another non-limiting exemplary embodiment of the inventive apparatus for holding a mobile communication device showing fold-away finger loops disposed in a lower central location of the back of a phone case;

FIG. 22 is a perspective front view of the embodiment shown in FIG. 20, showing the fold-away finger loops in a fully open position;

FIG. 23 is a perspective side view of the embodiment shown in FIG. 20, showing the fold-away finger loops in a partially open position;

FIG. 24 is a perspective back view of another non-limiting exemplary embodiment of the inventive apparatus for holding a mobile communication device showing fixed finger loops disposed around the perimeter edges of a phone case;

FIG. 25 is a perspective front view of the embodiment shown in FIG. 24, showing the fixed finger loops;

FIG. 26 is a perspective back view of the embodiment shown in FIG. 24, showing the fixed finger loops;

FIG. 27 is a perspective front view of another non-limiting exemplary embodiment of the inventive apparatus for holding a mobile communication device showing fixed finger loops configured as a substantially flat structure adhesively mountable to a back surface of a phone or phone case;

FIG. 28 is a perspective side view of the embodiment shown in FIG. 27, showing the fixed finger loops;

FIG. 29 is a perspective back view of the embodiment shown in FIG. 27, showing the fixed finger loops;

FIG. 30 is a perspective back view of another non-limiting exemplary embodiment of the inventive apparatus for holding a mobile communication device showing elastic finger loops disposed along side perimeter edges of a phone or phone case;

FIG. 31 is a back view of the embodiment shown in FIG. 30, showing pull tabs of the elastic finger loops;

FIG. 32 is a perspective side view of the embodiment shown in FIG. 30, showing a finger receiving gap formed in the elastic finger loops; and

FIG. 33 is a back view of the embodiment shown in FIG. 30, showing the finger receiving gap formed in the elastic finger loops.

### DETAILED DESCRIPTION OF THE INVENTION

For purposes of promoting an understanding of the principles of the invention, reference will now be made to the embodiments illustrated in the drawings and specific language will be used to describe the same. It will nevertheless be understood that no limitation of the scope of the invention is thereby intended, there being contemplated such alterations and modifications of the illustrated device, and such further applications of the principles of the invention as disclosed herein, as would normally occur to one skilled in the art to which the invention pertains.

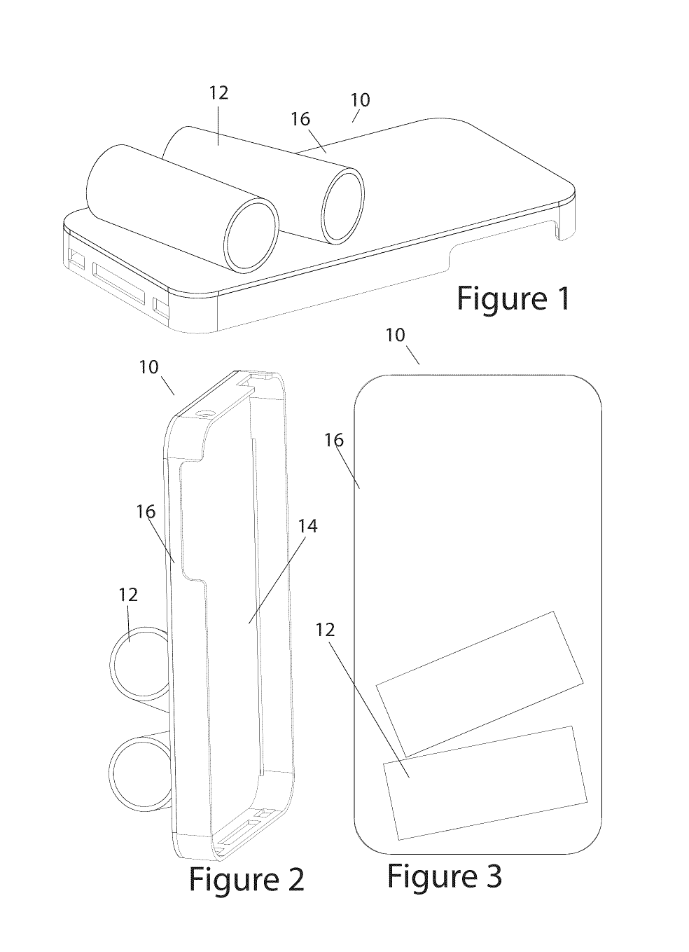

FIG. 1 is a perspective view of a non-limiting exemplary embodiment of the inventive apparatus disposed on a hard plastic case configured and dimensioned for receiving, engaging and supporting a mobile communication device, such as a cell phone, showing finger-engaging structures comprised of finger tubes configured and dimensioned for receiving and engaging two fingers of the hand a user so that the mobile communication device can be held securely and extended in a cantilevered fashion from the two fingers of the hand of the user. FIG. 2 is another perspective view of the embodiment of the inventive apparatus shown in FIG. 1 showing the hard plastic case defining an internal cavity for receiving, engaging and supporting a mobile communication device, such as a cell phone, and cut outs for providing access to buttons and other input/output devices of the cell phone. FIG. 3 is a back view of the embodiment of the inventive apparatus shown in FIG. 1, showing the finger-engaging structures disposed at an ergonomic angle relative to the display screen of a mobile communication device held in the hard plastic case effective to accommodate the fingers of the user which are placed in or inserted through the finger-engaging structure in order to hold a communication device resourcefully for enhanced use of the mobile communication device, such as taking selfie photos, movies or candida of others.

In accordance with the inventive apparatus, a user is able to extend the phone off the finger tips to enhance the use of the cellphone, especially cellphones with a larger screen size. The inventive apparatus allows a user to securely hold the cellphone with an outstretched hand and take a steady selfie with the same hand. The inventive apparatus enables a user to click the camera shutter while holding the phone at the maximum distance. Advantages of the inventive apparatus include greater dexterity to operate the phone, especially for the thumb of the hand holding the cellphone.

In accordance with various embodiments, some of which are depicted in the drawing figures, the inventive apparatus position finger-grasp structures having an appropriate angle, location and size so that a cellphone can be easily extended from and held securely by the fingertips of an outstretched arm.

As shown in FIGS. 1-3, the inventive apparatus holds a mobile communication device so that the mobile communication device is held securely with enhanced dexterity for manipulation and access of touchscreen user inputs and physical buttons for controlling the mobile communication device. In accordance with the inventive apparatus, at least one finger-receiving and engaging structure is fixable to a mobile communication device. The finger-receiving and engaging structure receives at least one finger of a hand of a user when fixed to the mobile communication device so that when in use, the mobile communication device is secured to said at least one finger and extendable in a cantilevered fashion from said at least one finger of the hand the user.

In accordance with a non-limiting exemplary embodiment, the inventive apparatus includes a shell for holding the cellphone and finger-grasp structures that can fold flat against the back of the shell when not in use. The inventive apparatus makes it easy to do, for example, typically difficult to achieve operations, such as one-handed texting since, one can get to the touchscreen keyboard with one's thumb (which is very difficult to do when holding a communication device, such as a typically sized smartphone, in one hand because the phone is just too wide).

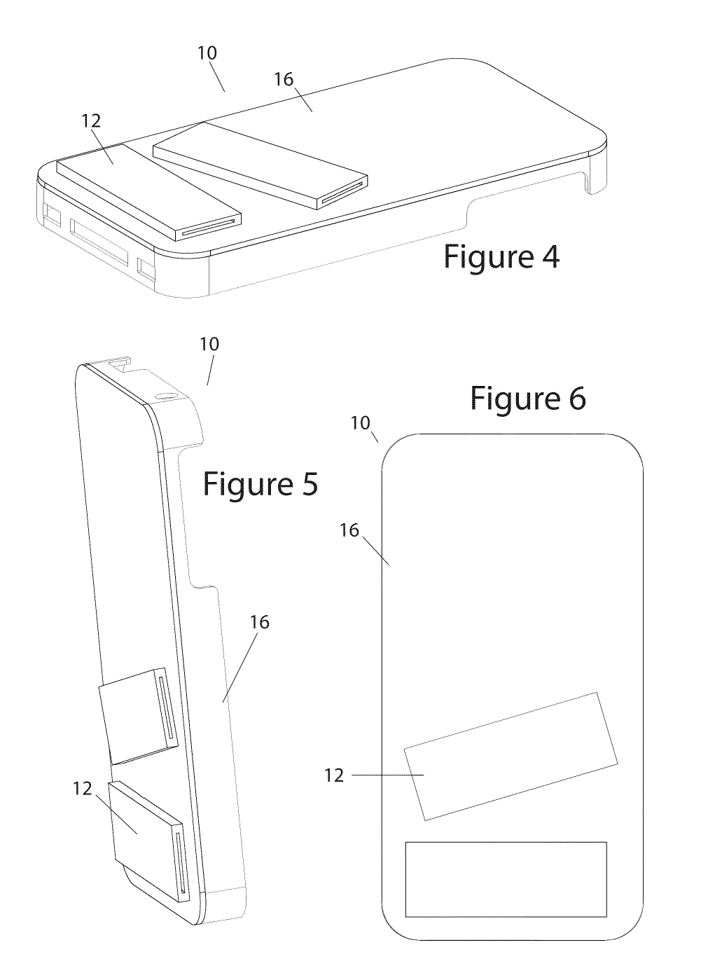

FIG. 4 is a perspective view of another non-limiting exemplary embodiment of the inventive apparatus for holding a mobile communication device showing finger-engaging structures comprised of collapsable finger sleeves, the collapsable finger sleeves being configured and dimensioned to collapse close to the back of the mobile communication device, or a case holding the mobile communication device. FIG. 5 is another perspective view of the embodiment of the inventive apparatus shown in FIG. 4 showing the collapsable finger sleeves collapsed tight against the back of the shell case. FIG. 6 is a back view of the embodiment of the inventive apparatus shown in FIG. 4, showing the finger-engaging structures disposed at the ergonomic angle relative to the display screen of a mobile communication device held in the hard plastic case.

As illustrated in the various exemplary embodiments shown in the drawings, the finger-receiving and engaging structures may comprise at least one of finger loops, a sleeve, an upside down pocket, an upside down fold out tray-like structure, a mitten-like structure, or the like. The finger-receiving and engaging structure is disposed at an angle, location and size relative to the display of the mobile communication device so that the mobile communication device can be easily extended from and held securely by the fingertips of an outstretched arm of the user.

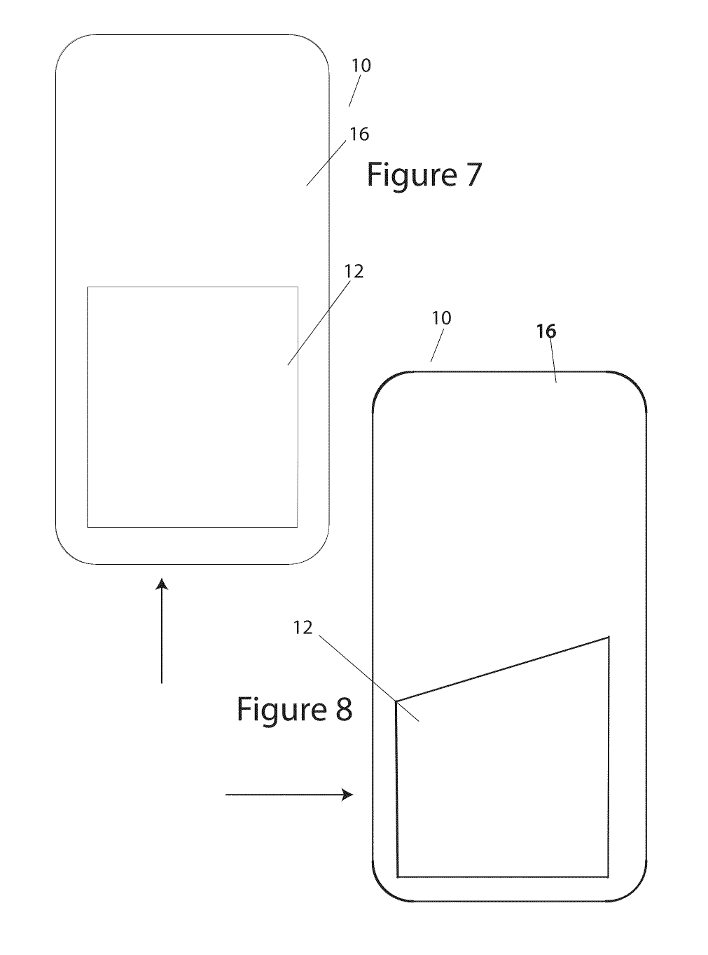

FIG. 7 is a back view of another non-limiting, exemplary embodiment of the inventive apparatus for holding a mobile communication device showing the finger-engaging structures comprised of a downwardly opening, or upside-down pocket, that receives one or more fingers of the user to extend the mobile communication device off the finger tips to enhance the use of the cellphone, especially smartphones with a larger screen size. In accordance with the embodiments show in the drawing figures, the finger-receiving and engaging structure can be fixed to a shell. The shell is configured and dimensioned to hold the mobile communication device so that each finger-receiving and engaging structure is disposed at the back side of the mobile communication with a front side of the mobile communication device having a display screen facing the user. The shell may be formed from a hard plastic, fabric, flexible plastic, leather, elastic fabric, patent-leather, and the like.

In accordance with a non-limiting, exemplary embodiment of the inventive apparatus, the finger-receiving and engagement structure may comprise an upside down pocket or an upside down fold out hard plastic case with a groove in the back having a finger ring that folds out (not shown). When folded in the stowed position, the hard plastic engagement structure can be configured and dimensioned to be flush with the back of the case. When in the folded out position the engagement structure is firm and securely slides over the fingers. The flip out ring (which may be a connected set of three finger rings, for example), could have jewels or spikes, brass knuckles, or other atheistic additions.

FIG. 8 is a back view of another non-limiting, exemplary embodiment of the inventive apparatus for holding a mobile communication device showing the finger-engaging structures comprised of a sleeve having a slanted edge for receiving and engaging with one or more fingers of the user to position the mobile communication device relative to the outwardly extended hand of the user to enable the user to hold the mobile communication device securely while freeing up the thumb or finger used to, for example, snap a picture or control a video mode of the mobile communication device. In accordance with this embodiment of the inventive apparatus, the finger-receiving and engaging structures may comprise a sleeve having an opening at one side. The sleeve is configured and dimensioned so that when in use, the received finger(s) are slid into the opening and hold that mobile communication device in an orientation with the display screen facing the user and the thumb of the hand of the user has enhanced dexterity for accessing a touchscreen button or physical button located in the vicinity of the display screen.

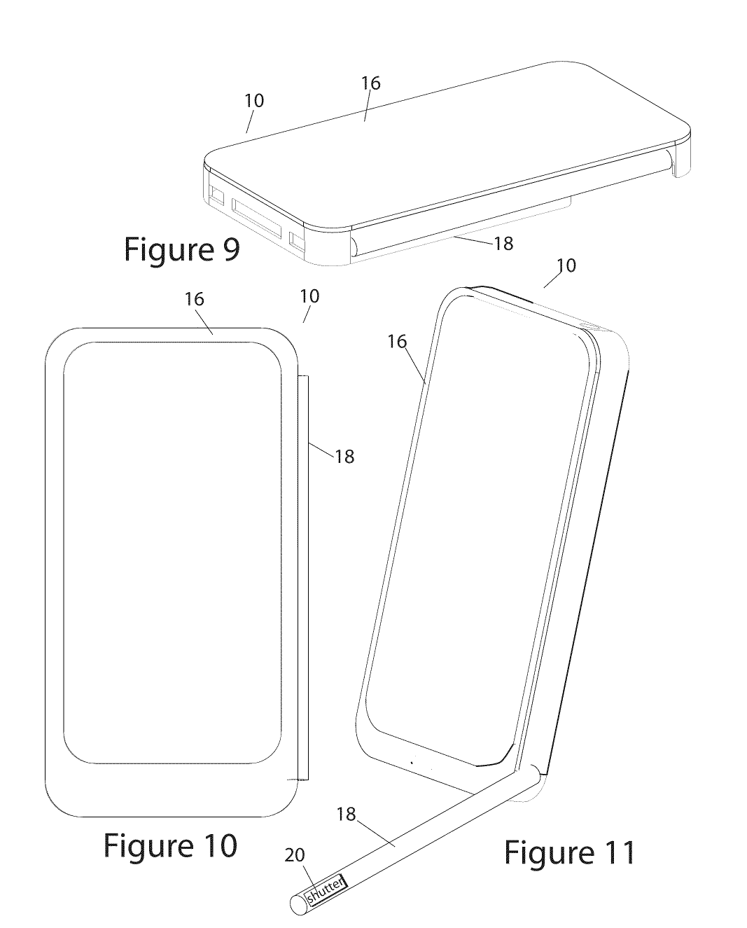

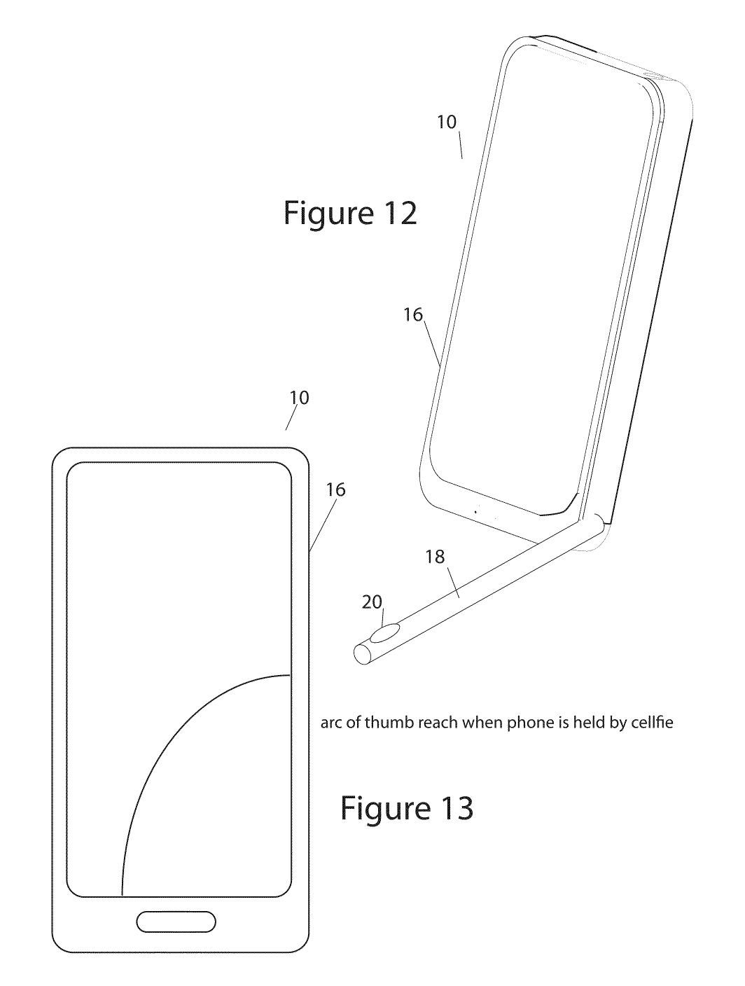

FIG. 9 is a perspective view of another non-limiting exemplary embodiment of the inventive apparatus for holding a mobile communication device showing a boom device. FIG. 10 is a front view of the embodiment shown in FIG. 9, showing the boom device positioned in a stowed location against the cell phone case. FIG. 11 is a perspective view of the embodiment shown in FIG. 9, showing the cell phone case positioning the cell phone so that when the boom device is pivoted from the stowed location and pulled down from the side of the phone to enable extending the phone away from the body of the user. In accordance with a non-limiting example, the phone is extendable as far as the supporting antenna can reach, but no further than the length of the user's other arm to push the shutter, including a button on the base of the distal end of the boom device. The user actuates the button to control the cellphone to, for example, snap photos or turn on and off a video. FIG. 12 is a perspective view of the embodiment shown in FIG. 9, showing a plug connected to an access port of the cellphone and wired through a hollow in the boom device to the switch. As shown in FIGS. 9-12, the pivoting boom member has a near end and a distal end. The near end is attached at a pivot fixable relative to the mobile communication case so that the distal end can be gripped by the user to extend the mobile communication device away from the user. In accordance with this aspect of the invention, the boom device may be pulled down from the side of the case (which may be hidden into the case when in the stowed position) and be used to extend the mobile communication device a further distance away to capture more of the area around the user, or to position the mobile communication device to capture other scenes that may not include the user, when using the device to capture a video or still image. For example, in accordance with this aspect of the invention, the boom is held with one hand of the user while the shutter is pushed with the other allowing greater reach away for wider and larger selfies from greater distances (at least that of the length of the user's arm up, down or sideways). With the use of a wired or wireless control switch, the boom can also be telescoping to further extend the range of use of the inventive apparatus and mobile communication device combination.

FIG. 13 schematically illustrates an arc of enhanced thumb access to the display screen and buttons on the face and sides of the cellphone in accordance with the use of the inventive apparatus. The use of the inventive apparatus provides an enhanced “accessibility arc” to the thumb and/or fingers of the user that assists many uses of the mobile communication device, such as one-handed texting, in addition to selfies. Not only is the difficulty of holding a cellphone steady with one hand when hitting the shutter button with your thumb alleviated, other features are enabled by having a phone securely held at user's finger tips (that is, not gripped in the palm of user's hand).

In accordance with the inventive apparatus, the user's thumb is disposed, for example, in a much more accessible position for one-handed texting (both the locations on the screen and the angle they can be reached by the thumb change dramatically when you are using your invention). In accordance with the use of the inventive apparatus described herein and as shown in the photos of the exemplary experimental prototype of the inventive apparatus, the user is enabled to hold a communication device, such as a cellphone securely at the user's fingertips, and swipe the user's thumb across the screen, with an enhanced “arc of accessibility” for the thumb as compared with holding the cellphone without the advantages of the inventive apparatus. Typically, a mobile communication device, such as a smartphone, has a touchscreen keyboard that is laid out within a one-size-fits-all rectangular box. The inventive apparatus may utilize an application or “app” running on the mobile communication device, that makes use of the natural enhanced accessibility arc of the user's thumb while using the inventive apparatus as described herein. The app may include automatic calibration and customization for each user, since everyone's hand is different, so the accessibility arc can be utilized to create a customized keyboard or icon layout on the touchscreen of the smartphone. Also, there are locations in the area defined by the accessibility arc that are easier to target and hit with, for example, the thumb then others. So, the location, placement and size of the letters or control icons can also be determined by, for example, the frequency of use for each particular letter of the alphabet or a user setting that defines which feature (i.e., control icon) should be easiest to access when the inventive apparatus is in use for holding the communication device. Further, the app may include a remote control and/or timer function used, for example, in conduction with the boom shown in FIGS. 9-12, to time the shutter and allow the phone to be held as far away from the user as the boom will allow.

In accordance with the inventive apparatus, as shown in exemplary alternative embodiments herein, and other alternative embodiments, the finger-receiving and engagement structures may comprise, for example, slots, tubes, finger rings, loops, sleeves or the like provided at ergonomic angles to accommodate human fingers which are placed in or inserted through these openings/tubes/slots/holes in order to hold a communication device conveniently/safely/resourcefully in order to take selfie photos, movies or candida of others. The finger-receiving and engagement structures may be applied as self contained, self-adhesive articles that can be fixed directly to the back or sides of a mobile communication device, integrally formed or fixed to a case, or applied as additions to an existing case. The inventive apparatus allow the user to hold the phone with their fingers through the finger-receiving and engagement structures while freeing up the thumb and/or other finger(s) which can be used, for example, to snap a picture or control a video mode by manipulating a user-input device (such as a button or touchscreen icon) on the display, front face or sides of the device or case holding the device. In accordance with the intended use of the inventive apparatus, there is no longer a need to apply significant pressure by the other fingers of the user resulting in holding the mobile communication device at an often awkward and unsteady angle. The user's ability to adjust the thumb/finger angle/length/pressure on the snap/control button on the screen is also not restricted. The capabilities enabled for the use of the mobile communication device, in accordance with the intended use of the inventive apparatus, allows selfie photos/movies and candida of others to be taken without dropping the phone, or the phone moving during shots, and allows the phone to remain more easily disposed at an intended angle and at pointed at an intended target without further manipulation, twitching, jerking or dropping of the mobile communication device. The inventive apparatus, as described in more detail herein, allows the user to enjoy taking photos/movies/skype/I chat and other applications while safely and comfortably holding the cell phone or device.

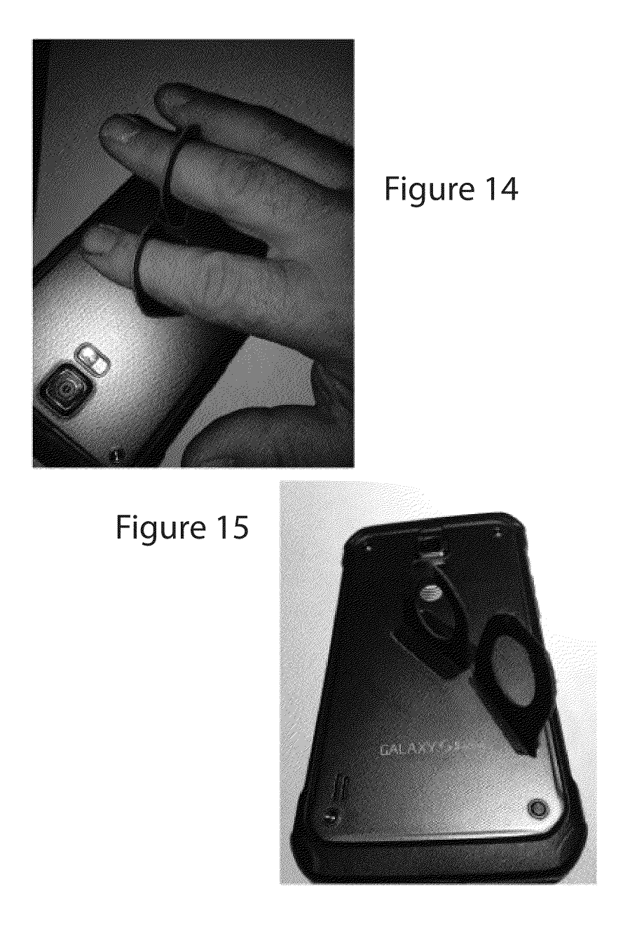

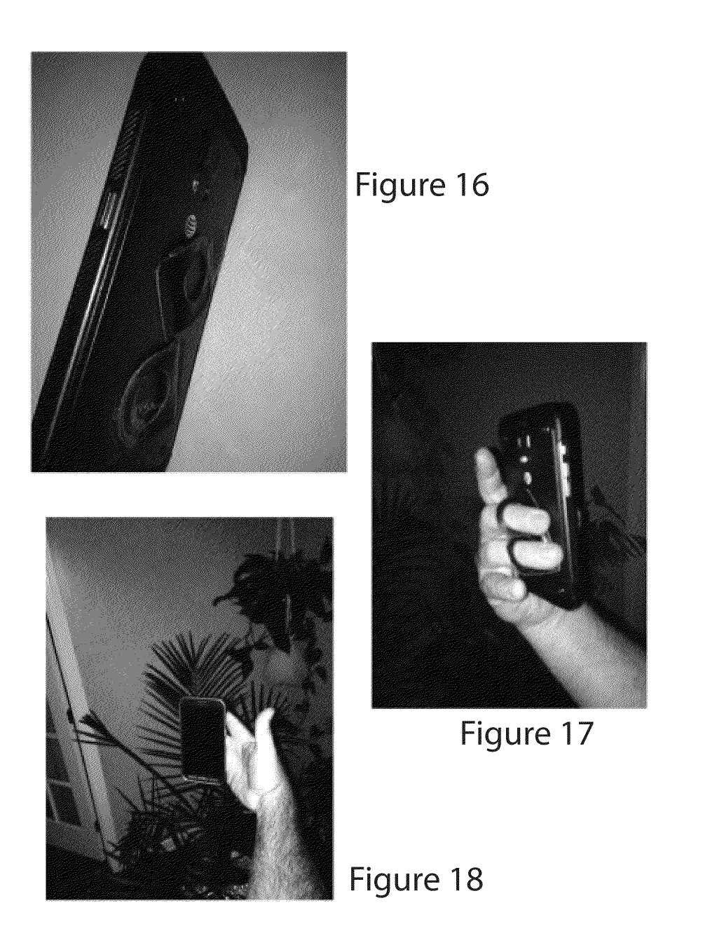

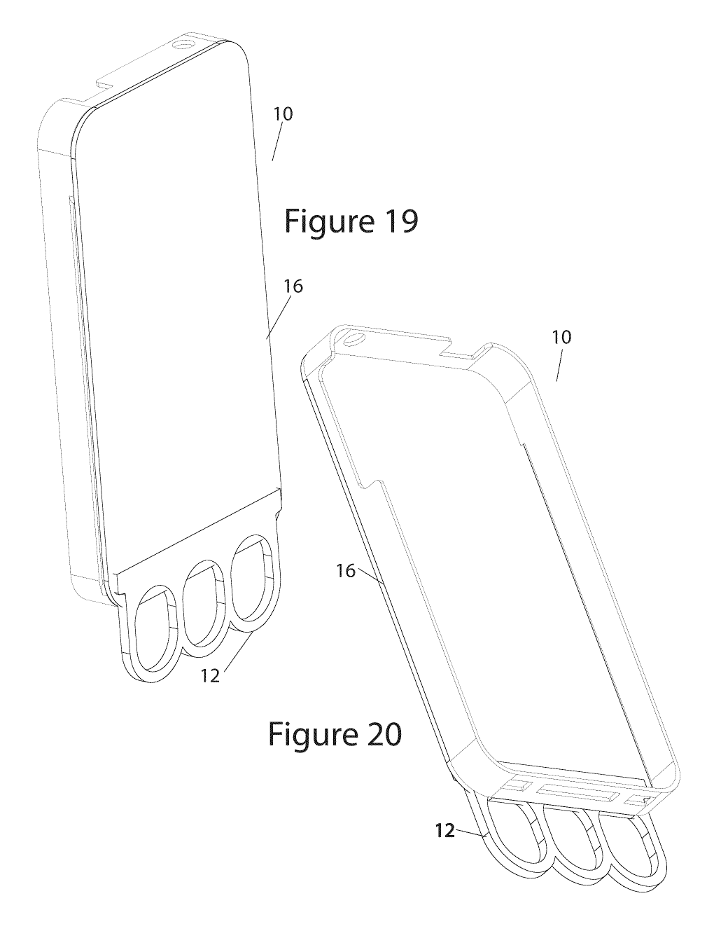

FIG. 14 is a photo showing a non-limiting, experimental exemplary embodiment of the inventive apparatus disposed directly on the back of a recent generation smartphone having a relatively large screen as compared with earlier generation smartphones, and showing finger-engaging structures comprised of self-adhesive finger loops. FIG. 15 is a photo showing the back of the exemplary embodiment shown in FIG. 14. FIG. 16 is a photo showing a side perspective view of the exemplary embodiment shown in FIG. 14. FIG. 17 is a photo showing the exemplary embodiment shown in FIG. 14, with the smartphone being securely held by the finger tips of a user. FIG. 18 is a photo showing the smartphone held by the exemplary embodiment shown in FIG. 14, showing the perspective from the user looking at the display screen of the smartphone held out extended from the outstretched arm of the user. The finger-receiving and engagement structures, such as the finger loops shown in the photos of FIGS. 14-18, and the other exemplary embodiments, or other non-illustrated embodiments, may be configured and dimensioned to fit into a groove or cut out that is substantially the shape and size of the finger-receiving and engagement structure so that when disposed in a stowed position, the finger-receiving and engagement structure sits flush with the case holding the mobile communication device. The finger-receiving and engagement structures may be plastic, leather, silicone, rubber, or chromed plastic, for example, and hinged to the case so as to fold in and out. When in the out position, in accordance with the use of the inventive apparatus, the user's fingers can comfortably hold the mobile communication steady and the thumb of the user can can more easily manipulate, for example, the “click camera” icon on the device's display screen or a button on the face or sides of the device. The finger-receiving and engagement structure may be decorated to have an aesthetically appealing look that is specific for, for example, to the fashion tastes of young girls, or may be configured and dimensioned to look like rings, or could be kept very modern and clean looking for males and adults.

FIG. 19 is a perspective back view of another non-limiting exemplary embodiment of the inventive apparatus for holding a mobile communication device showing fold-away finger loops disposed in an open position along a bottom edge of a phone case. FIG. 20 is a perspective front view of the embodiment shown in FIG. 19, showing the fold-away finger loops disposed in an open position along a bottom edge of a phone case. In accordance with this exemplary embodiment, a finger-receiving and engaging structure is comprised of a fold-away member that is hinged on the back surface of a phone case so that it can be deployed for use by swinging the fold-away member so that the finger loops of the fold-away member are positioned extending away from the bottom edge of the cellphone. When in the deployed position, the finger loops receive at least one finger of the user and allow the user to securely hold the cellphone by the finger tips of an extended hand with the palm of the hand holding the cellphone facing up. When the user's hand is in this position, the thumb of the hand holding the cellphone can easily access, for example, a touchscreen or control button disposed near the bottom of the cellphone. Comfortable and steady access to such control features of the cellphone enabled in accordance with this exemplary embodiment facilitate the taking of clear self-portrait photos using a camera of the cellphone.

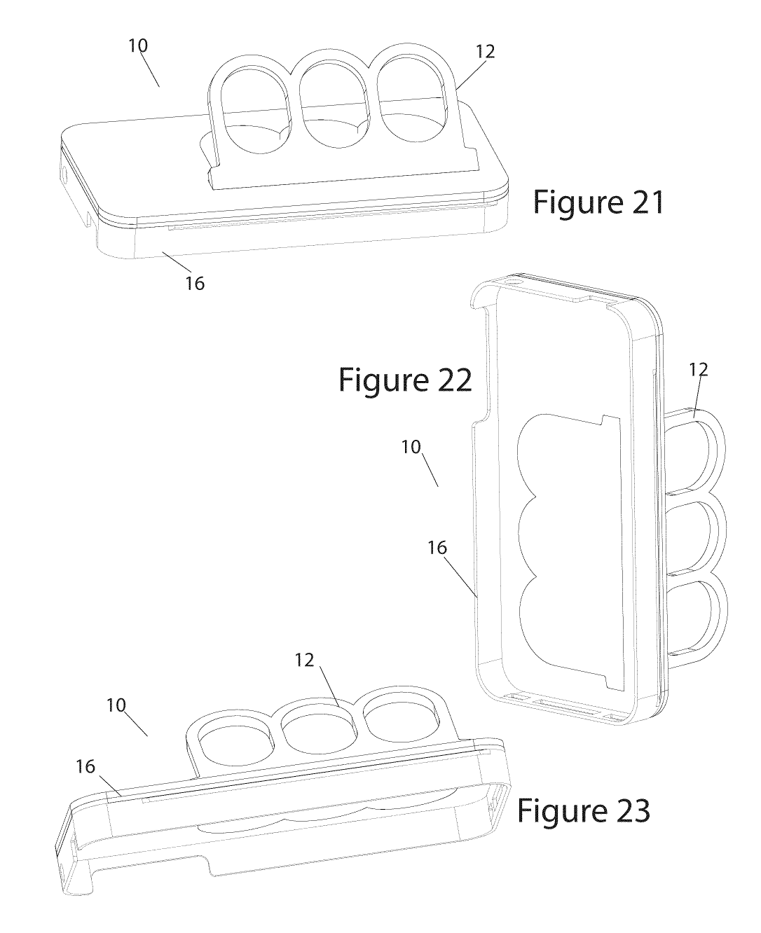

FIG. 21 is a perspective back view of another non-limiting exemplary embodiment of the inventive apparatus for holding a mobile communication device showing fold-away finger loops disposed in a lower central location of the back of a phone case. FIG. 22 is a perspective front view of the embodiment shown in FIG. 20, showing the fold-away finger loops in a fully open position. FIG. 23 is a perspective side view of the embodiment shown in FIG. 20, showing the fold-away finger loops in a partially open position. Similar to the embodiment shown in FIGS. 19 and 20, in accordance with the exemplary embodiment show in FIGS. 21-23 a finger-receiving and engaging structure is comprised of a fold-away member that is hinged on the back surface of a phone case. In accordance with this embodiment, the fold-away member can be deployed for use by swinging the fold-away member so that the finger loops of the fold-away member are positioned extending away from a longitudinal side edge of the cellphone. When in the deployed position, the finger loops receive at least one finger of the user and allow the user to securely hold the cellphone by the finger tips of an extended hand with the palm of the hand holding the cellphone facing substantially perpendicular to the long edge of the cellphone. In both exemplary embodiments shown in FIGS. 19-23, the user can easily switch between taking photos in portrait and landscape modes by rotating the hand holding the cellphone 90 degrees. Also, the finger-loops are configured and dimensioned so that there is room within each finger-loop to allow the respective finger engaged in a corresponding finger-loop to easily slide into the finger-loop and the user to find a comfortable position and desired angle at which to securely dispose the cellphone. As clearly shown in FIGS. 21-23, in accordance with these exemplary embodiments, when not in the deployed position, the fold-away member can be folded up and tucked flat against the back surface of the cellphone case so that when closed (i.e., in the folded up position) the back surface of the cellphone case is substantially flat and smooth, making it more easily slid into a pocket, for example, on clothing worn by the user.

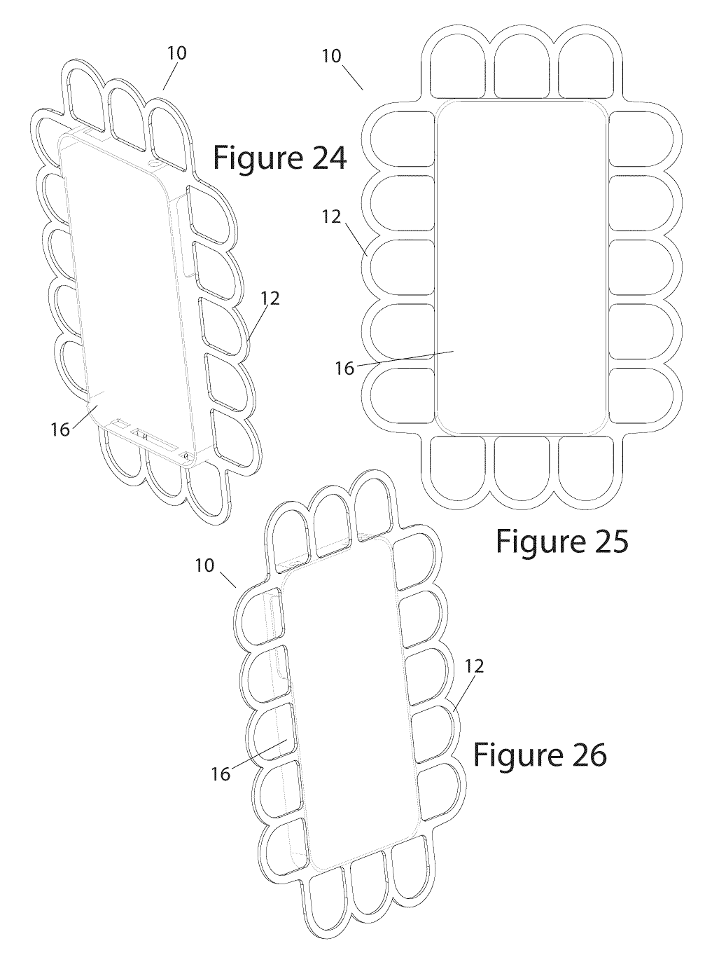

FIG. 24 is a perspective back view of another non-limiting exemplary embodiment of the inventive apparatus for holding a mobile communication device showing fixed finger loops disposed around the perimeter edges of a phone case. FIG. 25 is a perspective front view of the embodiment shown in FIG. 24, showing the fixed finger loops. FIG. 26 is a perspective back view of the embodiment shown in FIG. 24, showing the fixed finger loops. In accordance with this non-limiting exemplary embodiment, at least one finger-receiving and engaging structure is fixable to a mobile communication device. The finger-receiving and engaging structure receives and is engaged with at least one finger of a hand of a user. The at least one finger-receiving and engaging structure comprises at least one of finger loops extending from an edge of the mobile communication device when engaged with the mobile communication device. The finger looks extending from the edge of the mobile communication device are configured and dimensioned so that when in use, the mobile communication device is secured to said at least one finger and extendable in a cantilevered fashion from said at least one finger of the hand the user. In accordance with this exemplary embodiment, the finger-loops enable a user to hold the mobile communication device at a maximum distance away from the user by fully extending the arm of the hand having fingers engaged in the finger loops. The mobile communication device can be help at, for example, the farthest knuckle or fingertip of fingers engaged in the finger-loops with these engaged fingers held in an outstretched posture. In this case, the mobile communication device is held at a maximum distance available to the particular physique of the user (e.g., the length of the user's arm including the outstretched fingers), while still enabling convenient access to the control buttons and/or touch screen of the mobile communication device by the thumb of the hand holding the mobile communication device. The finger-loops may be provided around one or more peripheral edge, and as shown in FIGS. 24-26, finger-loops can be provided along all four peripheral edges of the mobile communication device. This configuration enables the mobile communication device to be easily grasped and held, as described above, from any of the edges, enabling access to various control buttons disposed at various locations on the touchscreen or control buttons located along any of the edges of the mobile communication device, while also enabling comfortable positioning of the mobile communication device at angles relative to the user to allow, for example, portrait or landscape photographs to be taken.

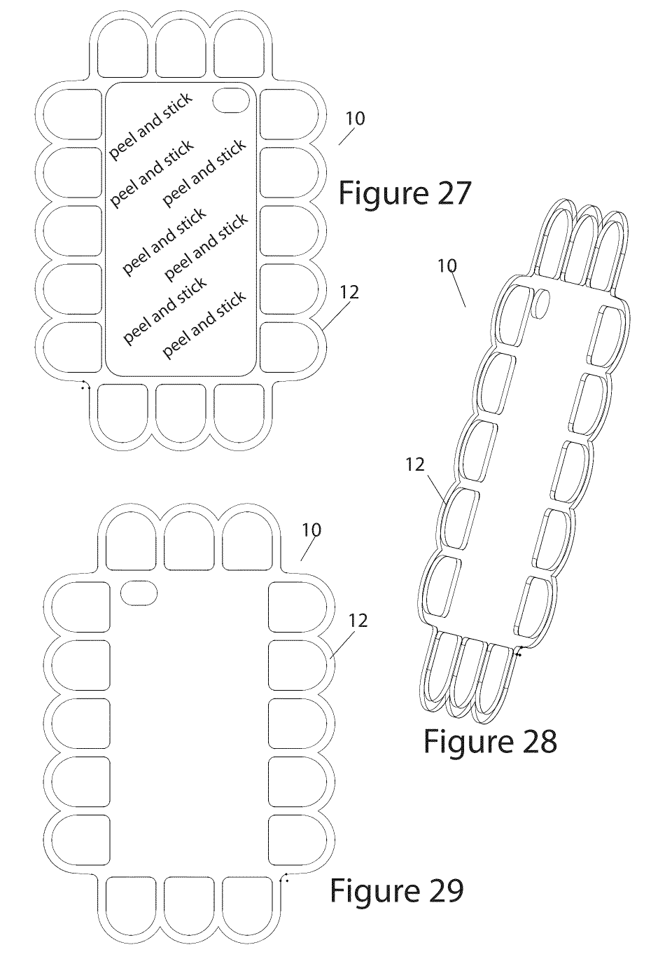

FIG. 27 is a perspective front view of another non-limiting exemplary embodiment of the inventive apparatus for holding a mobile communication device showing fixed finger loops configured as a substantially flat structure adhesively mountable to a back surface of a phone or phone case. FIG. 28 is a perspective side view of the embodiment shown in FIG. 27, showing the fixed finger loops. FIG. 29 is a perspective back view of the embodiment shown in FIG. 27, showing the fixed finger loops. In accordance with this exemplary embodiment, the finger-receiving and engaging structure integrally formed with a substantially thin and flat planar member. A fixing mechanism is provided for fixing the planar member to a back surface of a mobile communication or a back surface of a case holding the mobile communication device. The fixing mechanism may comprise, for example, a hook and loop fastening system for removably fixing the planar member to the back surface of the mobile communication device of the back surface of the case holding the mobile communication device. Alternatively, the fixing mechanism may comprises a pressure sensitive adhesive for semi-permanently fixing the planar member to the back surface of the mobile communication device of the back surface of the case holding the mobile communication device.

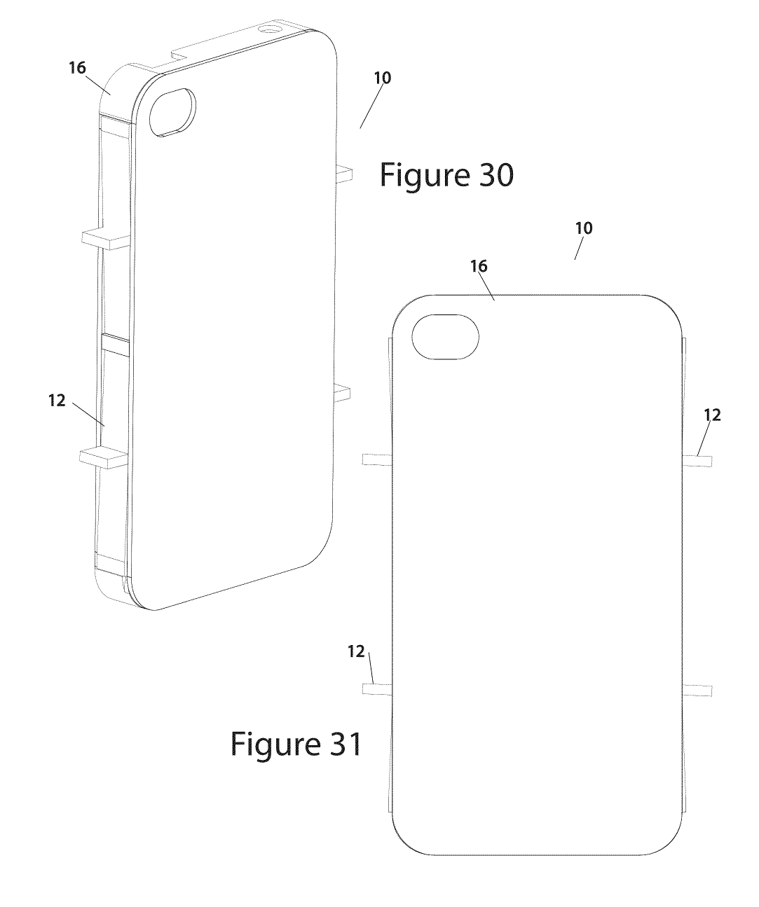

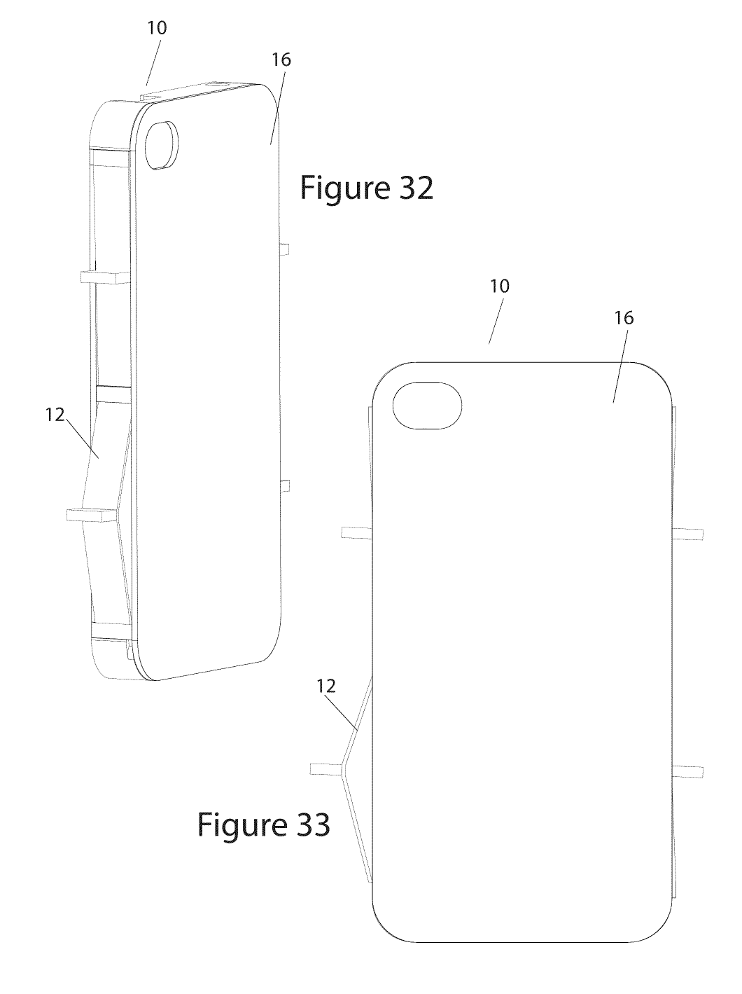

FIG. 30 is a perspective back view of another non-limiting exemplary embodiment of the inventive apparatus for holding a mobile communication device showing elastic finger loops disposed along side perimeter edges of a phone or phone case. FIG. 31 is a back view of the embodiment shown in FIG. 30, showing pull tabs of the elastic finger loops. FIG. 32 is a perspective side view of the embodiment shown in FIG. 30, showing a finger receiving gap formed in the elastic finger loops. FIG. 33 is a back view of the embodiment shown in FIG. 30, showing the finger receiving gap formed in the elastic finger loops.

FIG. 30 is a perspective back view of another non-limiting exemplary embodiment of the inventive apparatus for holding a mobile communication device showing elastic finger loops disposed along side perimeter edges of a phone or phone case. FIG. 31 is a back view of the embodiment shown in FIG. 30, showing pull tabs of the elastic finger loops. FIG. 32 is a perspective side view of the embodiment shown in FIG. 30, showing a finger receiving gap formed in the elastic finger loops. FIG. 33 is a back view of the embodiment shown in FIG. 30, showing the finger receiving gap formed in the elastic finger loops.

In accordance with another non-limiting exemplary embodiment of the inventive apparatus, at least one finger-receiving and engaging structure is fixed to a mobile communication device for receiving and engaging at least one finger of a hand of a user. The at least one finger-receiving and engaging structure may comprise an elastic member disposed along at least one outer side of the mobile communication device or a case holding the mobile communication device. The elastic member when in an unstretched, underplayed mode is disposed in a relatively closer proximity from the outer side. When in a stretched, deployed mode, the elastic member is disposed in a relatively farther proximity from the outer side so that in the stretched, deployed mode the elastic member forms a gap between the elastic member and the outer side for receiving and engaging the at least one finger of the user so that when in use the mobile communication device is secured to said at least one finger and extendable in a cantilevered fashion from said at least one finger of the hand the user. The elastic member may include a pull-tab disposed along an outer face of the elastic member to facilitate disposing the elastic member in the stretched, deployed mode.

The various elements making up each embodiment of the present invention can be interchanged in a variety of iterations, not all of which are provided as specific embodiments or examples herein. Features and structures described in one embodiment may be employed, although not specifically described, in an alternative construction of another embodiment. Such iterations are specifically included within the scope of the inventions described herein.

With respect to the above description, it is realized that the optimum dimensional relationships for parts of the invention, including variations in size, materials, shape, form, function, and manner of operation, assembly and use, are deemed readily apparent and obvious to one skilled in the art. All equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents may be resorted to, falling within the scope of the invention.

1. An apparatus for holding a mobile communication device, comprising:
at least one finger-receiving and engaging structure fixable to a mobile communication device, the finger-receiving and engaging structure for receiving and engaging at least one finger of a hand of a user when engaged with the mobile communication device so that when in use the mobile communication device is secured to said at least one finger and extendable in a cantilevered fashion from said at least one finger of the hand the user.

2. The apparatus according to claim 1; wherein the at least one finger-receiving and engaging structure comprises at least one of finger loops, a sleeve, an upside down pocket, an upside down fold out tray-like structure, a mitten-like structure; wherein the finger-receiving and engaging structure is disposed at an angle, location and size relative to the display of the mobile communication device so that the mobile communication device can be easily extended from and held securely by the fingertips of an outstretched arm of the user.

3. The apparatus according to claim 1; wherein the at least one finger-receiving and engaging structure comprises a sleeve having an opening at one side and is configured and dimensioned so that when in use, the received said at least one finger holds that mobile communication device in an orientation with the display screen facing the user and the thumb of the hand of the user has enhanced dexterity for accessing a touchscreen button or physical button located in the vicinity of the display screen.

4. That apparatus according to claim 1; further comprising a pivoting boom member having a near end and a distal end, the near end being attached at a pivot fixable relative to the mobile communication case so that the distal end can be gripped by the user to extend the mobile communication device away from the user.

5. The apparatus according to claim 1; wherein said at least one finger-receiving and engaging structure is fixed to a shell, wherein the shell is configured and dimensioned to hold the mobile communication device so that said at least one finger-receiving and engaging structure is disposed at the back side of the mobile communication with a front side of the mobile communication device having a display screen facing the user.

6. The apparatus according to claim 5; wherein the shell is formed from a hard plastic, fabric, flexible plastic, leather, patent-leather, and the like.

7. An apparatus for holding a mobile communication device, comprising: at least one finger-receiving and engaging structure fixable to a mobile communication device, the finger-receiving and engaging structure for receiving and engaging at least one finger of a hand of a user, the at least one finger-receiving and engaging structure comprises at least one of finger loops extending from an edge of the mobile communication device when engaged with the mobile communication device so that when in use the mobile communication device is secured to said at least one finger and extendable in a cantilevered fashion from said at least one finger of the hand the user.

8. The apparatus according to claim 7; wherein said at least one finger-receiving and engaging structure is fixed to a shell, wherein the shell is configured and dimensioned to hold the mobile communication device so that said at least one finger-receiving and engaging structure is disposed at the back side of the mobile communication with a front side of the mobile communication device having a display screen facing the user.

9. The apparatus according to claim 8; wherein the shell is formed from a hard plastic, fabric, flexible plastic, leather, patent-leather, and the like.

10. The apparatus according to claim 7; wherein said at least one finger-receiving and engaging structure is integrally formed with a substantially thin and flat planar member; and further comprising a fixing mechanism for fixing the planar member to a back surface of a mobile communication or a back surface of a case holding the mobile communication device.

11. The apparatus according to claim 7; wherein the fixing mechanism comprises a hook and loop fastening system for removably fixing the planar member to the back surface of the mobile communication device of the back surface of the case holding the mobile communication device.

12. The apparatus according to claim 7; wherein the fixing mechanism comprises a pressure sensitive adhesive for semi-permanently fixing the planar member to the back surface of the mobile communication device of the back surface of the case holding the mobile communication device.

13. An apparatus for holding a mobile communication device, comprising:
At least one finger-receiving and engaging structure fixable to a mobile communication device, the finger-receiving and engaging structure for receiving and engaging at least one finger of a hand of a user, the at least one finger-receiving and engaging structure comprising an elastic member disposed along at least one outer side of the mobile communication device or a case holding the mobile communication device, wherein the elastic member in an unstretched, underplayed mode is disposed in a relatively closer proximity from the outer side and in a stretched, deployed mode is disposed in a relatively farther proximity from the outer side so that in the stretched, deployed mode the elastic member forms a gap between the elastic member and the outer side for receiving and engaging the at least one finger of the user so that when in use the mobile communication device is secured to said at least one finger and extendable in a cantilevered fashion from said at least one finger of the hand the user.

14. The apparatus according to claim 13; wherein said at least one finger-receiving and engaging structure is fixed to a shell, wherein the shell is configured and dimensioned to hold the mobile communication device so that said at least one finger-receiving and engaging structure is disposed parallel along at least one outer side of the mobile communication.

15. The apparatus according to claim 15; wherein the shell is formed from a hard plastic, fabric, flexible plastic, leather, patent-leather, and the like.

16. The apparatus according to claim 13; wherein the elastic member includes a pull-tab disposed along an outer face of the elastic member to facilitate disposing the elastic member in the stretched, deployed mode.

17. The apparatus according to claim 13; wherein said at least one finger-receiving and engaging structure is integrally formed with a substantially thin and flat planar member; and further comprising a fixing mechanism for fixing the planar member to a back surface of a mobile communication or a back surface of a case holding the mobile communication device.

18. The apparatus according to claim 13; wherein the fixing mechanism comprises a hook and loop fastening system for removably fixing the planar member to the back surface of the mobile communication device of the back surface of the case holding the mobile communication device.

19. The apparatus according to claim 13; wherein the fixing mechanism comprises a pressure sensitive adhesive for semi-permanently fixing the planar member to the back surface of the mobile communication device of the back surface of the case holding the mobile communication device.
